(19) United States
(12) Patent Application Publication
(10) Pub. No.: US 2017/0068964 A1
(43) Pub. Date: Mar. 9, 2017

(54) RANKING OF SPONSORED CONTENT ITEMS FOR COMPLIANCE WITH POLICIES ENFORCED BY AN ONLINE SYSTEM

(71) Applicant: Facebook, Inc., Menlo Park, CA (US)

(72) Inventors: Igor Gevka, Palo Alto, CA (US); Hongda Ma, Mountain View, CA (US); Satwik Shukla, Austin, TX (US); Yufei Chen, Mountain View, CA (US); Daniel Tam, San Francisco, CA (US); Emanuel Alexandre Strauss, San Mateo, CA (US); Daniel Olmedilla de la Calle, Menlo Park, CA (US); Sarang Mohan Joshi, Austin, TX (US)

(21) Appl. No.: 14/849,557

(22) Filed: Sep. 9, 2015

(51) Int. Cl. G06Q 30/00; G06Q 30/02

(52) U.S. Cl. CPC G06Q 30/018; G06Q 30/0273; G06Q 30/0277

(57) ABSTRACT

An online system receives advertisements from advertisers and reviews the advertisement for compliance with policies enforced by the online system. The online system computes scores for each advertisement based on an expected revenue from presenting various advertisement and/or interactions with various advertisements and orders advertisements for review based on their scores. If a predicted time for the online system to review an advertisement is greater than a threshold amount of time, the online system allows the online system to be evaluated for presentation to users. As the online system receives interactions with the advertisement, the online system may modify the score for the advertisement and modify the order of the advertisement for review based on the modified score.

### BACKGROUND

This disclosure relates generally to online systems, and in particular to reviewing sponsored content for compliance with polices enforced by an online system.

Many online systems generate revenue by allowing entities, such as businesses, to sponsor presentation of content by the online systems, allowing the entity to gain attention from online system users for the entity's products or services or to persuade online system users to take actions regarding the entity's products or services. An online system may receive compensation from an entity for presenting online system users with sponsored content provided by the entity to the online system. Frequently, online systems charge an entity for each presentation of sponsored content to an online system user (e.g., each “impression” of the sponsored content) or for each interaction with sponsored content by a social networking system user (e.g., each “conversion”). For example, an online system receives compensation from an entity each time a content item provided by the entity is displayed to a user on the online system or each time a user presented with the content item requests additional information about a product or service described by the content item by interacting with the content item (e.g., requests a product information page by interacting with the content item).

To prevent presentation of sponsored content from impairing user interactions, many online systems require sponsored content to comply with policies enforced by the online system for the sponsored content to be presented by the online system. Conventional, online systems review sponsored content items for compliance with policies enforced by an online system in the order the sponsored content items were received from entities. Some online systems prioritize review of sponsored content items from entities that have agreements with the online systems guaranteeing review of sponsored content items from the entities within a certain amount of time. However, this prioritization scheme does not account for various factors such as: potential revenue lost while a sponsored content is awaiting review, time-sensitivity issues requiring the expedited review of a sponsored content item, quality of a sponsored content item, or cost to review a sponsored content item.

### SUMMARY

An online system obtains revenue by presenting advertisements to its users. Advertisements presented by the online system are reviewed before presentation for compliance with one or more policies enforced by the online system, so advertisements that do not comply with a threshold number of policies enforced by the online system are not presented by the online system. Conventionally, online systems review advertisements in the order they are received from entities, such as advertisers. While certain online systems may score advertisements for review by applying a model to advertisements and identify a subset of the advertisements for manual review based on their scores, if the model used to score the advertisement changes over time, the subset of advertisements identified for manual review may also change over time, resulting in inefficient use of both computing and manual resources for processing and reviewing the subset of advertisements.

To more efficiently determine whether advertisements comply with policies enforced by the online system, the online system determines a score for advertisements received by the online system based on various factors, including a likelihood of the advertisements violating one or more of the policies. Additional examples of factors include the expected revenue for presenting an advertisement to online system users, the expected number of times the advertisement will be shown to users of the system, the expected level of interest of the online system users in the advertisement, the amount of resources used for reviewing the advertisement, the interactions by online system users with the advertisement, and the amount of time for the online system to review the advertisement. Based on the scores, the online system orders the advertisements in a queue. For example, advertisements having higher scores have higher orders in the queue. In another example, advertisements having lower scores have higher orders in the queue. Based on the order of advertisements in the queue, the online system evaluates the advertisements for compliance with policies enforced by the online system. Additionally, the online system determines a predicted time until advertisements in the queue will be reviewed for compliance with policies enforced by the online system based at least in part on the order of the advertisements in the queue and the resources available for reviewing advertisements. If the predicted time until an advertisement in the queue will be reviewed exceeds a threshold amount of time, the online system includes the advertisement in one or more selection processes for presentation to the user before the advertisement is reviewed. The threshold amount of time may vary for advertisements having different characteristics (e.g., advertisements received from different entities, advertisements for different types of products or services, or advertisements having different levels of importance).

If the online system receives interactions with an advertisement presented without being reviewed for compliance with policies enforced by the online system, the online system computes a modified score for the advertisement based at least in part on the received interactions with the advertisement. For example, the online system computes a modified score for an advertisement presented to a user if the online system receives certain interactions with the advertisement from users presented with the advertisement, such as interactions indicating a lack of interest in the advertisement (e.g., interactions where the user hides the advertisement or provides a complaint against the advertisement). When the online system receives user interactions with an advertisement that was presented to online system users before it was reviewed for compliance with policies enforced by the online system, the online system computes a modified score for the advertisement that accounts for the received user interactions with the advertisement. Based on the modified score, the online system modifies the order of advertisements in the queue for review against policies enforced by the online system. This allows the online system to prioritize or deprioritize the advertisement for review based on the received user interactions with the advertisement.

The online system may compute modified scores for advertisements and modify the order of the advertisements in the queue based on the modified scores when certain conditions are satisfied. For example, the online system computes modified scores for the advertisements if at least a threshold time interval has lapsed between a current time and a time when the one or more advertisements were ordered in the queue and modifies the order of the advertisements in the queue based on the modified scores. As another example, the online system computes modified scores for the advertisements if a model used to determine scores for the advertisements has been modified between a current time and a time when scores were generated for the advertisements. The modified scores account for interactions by users with advertisements presented by the online system between the current time and the time when the advertisements were ordered in the queue, changes in the cost to the online system to review advertisements between the current time and the time when the advertisements were ordered in the queue, or changes in other factors between the current time and the time when the advertisements were ordered in the queue. Based on the modified scores, the online system modifies the order of the advertisements in the queue, allowing the online system to modify the order in which various advertisements are reviewed for compliance with policies enforced by the online system over time without excessively delaying presentation of advertisements to online system users while awaiting review of the advertisements for compliance with policies enforced by the online system.

### BRIEF DESCRIPTION OF THE DRAWINGS

FIG. 1 is a block diagram of a system environment in which an online system operates, in accordance with an embodiment of the invention.

FIG. 2 is a block diagram of an online system, in accordance with an embodiment of the invention.

FIG. 3 is a flow chart of a method for ranking an advertisement to evaluate for compliance with policies enforced by an online system, in accordance with an embodiment of the invention.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

An online system derives revenue by presenting sponsored content items, such as advertisements, to its users and may perform various functions to present advertisements. For example, the online system acts as a publishing system by receiving advertisements from advertisers or other third party systems and presenting the advertisements directly to users. As another example, the online system acts as an advertising network by receiving advertisements from advertisers and providing the advertisements to other publishing websites. However, the online system may provide any functionality suitable for presenting advertisements to its users.

Often, an online system reviews advertisements for compliance with one or more policies enforced by the online system before the advertisements may be presented to users. Policies enforced by the online system may regulate content included in an advertisement to prevent presentation of advertisements including offensive or inaccurate content to users or to prevent presentation of advertisements including certain types of data to users. In some configurations, the online system divides received advertisements into components (e.g., title, content, image, landing page, etc.) and reviews individual components of an advertisement for compliance with one or more policies or reviews advertisements as a whole for compliance with one or more policies. An example of a component review process is further described in U.S. patent application Ser. No. 13/756,357, filed on Jan. 31, 2013, which is hereby incorporated by reference in its entirety.

To more efficiently review advertisements for compliance with polices enforced by the online system, the online system calculates a score for each advertisement based at least in part on an expected revenue to the online system for presenting an advertisement to users. Additional factors are also used by the online system to calculate a score for an advertisement. Examples of additional factors include: an advertiser experience metric that describes an amount of time for the online system to review an advertisement, a quality metric that indicates an expected level of interest of users of the online system in the advertisement, and a cost to review metric that indicates an estimated amount of resources (time and human and computer reviewers) used to review the advertisement.

Based on the scores computed for various advertisements, the online system orders the advertisements in a queue for review. In various embodiments, advertisements with higher orders in the queue are reviewed to determine whether the advertisements comply with one or more policies enforced by the online system sooner. To prevent advertisements from remaining in the queue for review against policies enforced by the online system rather than being presented to the user, the online system determines a predicted time until advertisements in the queue will be reviewed for compliance with policies enforced by the online system based at least in part on the order of the advertisements in the queue and the resources available for reviewing the advertisements. If the predicted time until an advertisement in the queue will be reviewed for compliance with the policies enforced by the online system exceeds a threshold amount of time, the online system includes the advertisement in one or more selection processes for presentation to the user before the advertisement is reviewed. The threshold amount of time may vary for advertisements having different characteristics (e.g., advertisements received from different entities, advertisements for different types of products or services, advertisements having different levels of importance).

If the online system receives interactions with an advertisement presented without being reviewed for compliance with policies enforced by the online system, the online system computes a modified score for the advertisement based at least in part on the received interactions with the advertisement. For example, the online system computes a modified score for an advertisement presented to a user if the online system receives certain interactions with the advertisement from users presented with the advertisement, such as interactions indicating a lack of interest in (e.g., interactions where the user hides the advertisement or provides a complaint against the advertisement). When the online system receives user interactions with an advertisement that was presented to online system users before it was reviewed for compliance with policies enforced by the online system, the online system computes a modified score for the advertisement that accounts for the received user interactions with the advertisement. Based on the modified score, the online system modifies the order of advertisements in the queue for review against policies enforced by the online system. Hence, the online system may present advertisements to users before reviewing the advertisements for compliance with polices enforced by the online system and subsequently expedite review of the advertisements for compliance with the policies based on received user interactions with the presented advertisements.

Advertisements or components of advertisements may be reviewed electronically or manually. The advertisements or components ordered in the queue may be electronically reviewed by default, but may be manually reviewed if there is an indication that electronic review will be inadequate. For example, if an advertisement contains several images, electronic review may be unable to accurately distinguish between images in compliance with a policy and images in violation of the policy. In such cases, the online system may direct the advertisement into a queue for manual review. In one embodiment, the online system maintains separate review queues for electronic review and for manual review. In another embodiment, the online system maintains only an electronic review queue or a manual review queue.

In addition to ranking advertisements or components of advertisements for review against policies enforced by the online system, scores computed for advertisements may help to update the online system's advertisement inventory. For example, if an advertisement surpasses a threshold amount of negative feedback after presentation (e.g., users indicating that they found the advertisement offensive, misleading, etc.), the online system computes a modified score for the advertisement that exceeds a threshold value causing review of the advertisement for possible remedial action. Example remedial actions by the online system include: removing the advertisement from its advertisement store, decreasing a bid amount for the advertisement, or increasing the cost to the advertiser for presenting the advertisement. Additional review of an advertisement may be manually performed if the initial review was electronically performed.

The computed scores may also be used to determine advertisement placement after review. In one embodiment, advertisements having scores indicating a higher value to the online system may be placed in more prominent locations to encourage user interaction. For example, advertisements having at least a threshold score are presented in a feed of stories presented to a user while advertisements with scores less than the threshold are presented in an advertisement-specific location.

### System Architecture

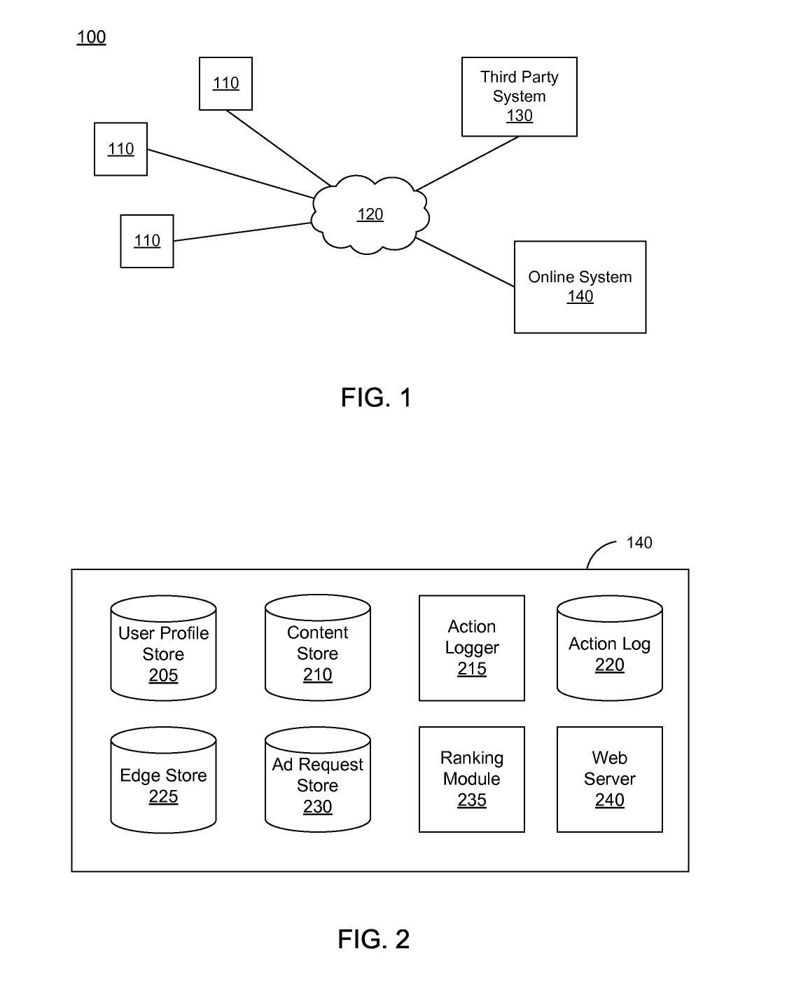

FIG. 1 is a block diagram illustrating a system environment 100 for an online system 140. The system environment 100 comprises one or more client devices 110, a network 120, one or more third party systems 130, and an online system 140, such as a social networking system. Users and advertisers connect to the online system 140 via client devices 110 through the network 120. In alternative configurations, different and/or additional components may be included in the system environment 100.

The client devices 110 comprise one or more computing devices capable of receiving user input as well as transmitting and/or receiving data via the network 120. In one embodiment, a client device 110 is a conventional computer system, such as a desktop or a laptop computer. In another embodiment, a client device 110 may be a device having computer functionality, such as a personal digital assistant (PDA), a mobile telephone, a smart-phone or other similar device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. As another example, a client device 110 interacts with the online system 140 through an application programming interface (API) that runs on the native operating system of the client device 110, such as IOS® or ANDROID™.

The client devices 110 are configured to communicate via the network 120, which may comprise any combination of local area and/or wide area networks, using both wired and wireless communication systems. In one embodiment, the network 120 uses standard communications technologies and/or protocols. Thus, the network 120 may include communication channels using technologies such as Ethernet, 802.11, worldwide interoperability for microwave access (WiMAX), 3G, 4G, code division multiple access (CDMA), digital subscriber line (DSL), etc. Similarly, the networking protocols used on the network 120 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 120 may be represented using technologies and/or formats including hypertext markup language (HTML) or extensible markup language (XML). In addition, all or some of the communication channels of the network 120 may be encrypted using conventional encryption technologies such as secure sockets layer (SSL), transport layer security (TLS), and Internet Protocol security (IPsec).

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an example architecture of the online system 140. The online system 140 includes a user profile store 205, a content store 210, an action logger 215, an action log 220, an edge store 225, an advertisement request (“ad request”) store 230, a ranking module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

Additionally, a user profile may include information used by a user to access the online system 140. For example, when a user logs into the online system 140, the online system 140 stores a device identifier of a client device 110 used to log into the online system 140 (e.g., an Internet Protocol address associated with the client device 110 in the user profile associated with the user. Additionally, login credentials associated with a user (e.g., a username and a password) are included in the user profile associated with the user, and the online system 140 may also store information identifying login credentials the user used to log into the online system 140 along with a time associated with each login to the online system 140 by the user. The online system 140 may retrieve information identifying a user from a request by the user to login to the online system 140 (e.g., a user identifier from a network address), retrieve an identifier of an application from which the request was received (e.g., a browser identifier) from the request, or retrieve a unique session identifier associated with the request, and store the retrieved information in the user profile associated with the user.

The online system 140 updates a user profile associated with a user based on information received from the user. For example, if a user updates login credentials used to access the online system 140, the online system 140 modifies the user profile associated with the user to include the updated login credentials. As another example, as a user accesses the online system 140 from different client devices 110, the online system 140 modifies the user profile associated with the user to include device identifiers or other information identifying the different client devices 110 (e.g., Internet Protocol addresses associated with the different client devices 110).

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, interactions with advertisements, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, an edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content (also referred to as an “advertisement”) and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

In some embodiments, the ad request store 230 stores ad requests including advertisements satisfying one or more policies of the online system 140 and does not store advertisements that do not satisfy one or more policies of the online system 140. Additionally, the ad request store 230 may remove ad requests after a threshold length of time lapses from a time when the ad request was stored. Other embodiments may maintain ad requests in the ad request store 230 even if advertisements included in the ad requests do not satisfy one or more policies of the online system 140 or after the threshold length of time from initial storage of the ad requests has lapsed.

The ranking module 235 generates a queue in which advertisements from various ad requests are ordered for review to determine compliance with one or more policies of the online system 140. In some embodiments, the ranking module 235 maintains a queue specifying an order in which components of various advertisements (e.g., title, landing page, image) are reviewed for compliance with one or more policies enforced by the online system 140. To generate the queue, the ranking module 235 determines scores for various advertisements and orders the advertisements in the queue based on their determined scores. A score for an advertisement is based at least in part on an expected revenue to the online system 140 for presenting an advertisement (or for presenting advertisements containing a component) to online system users. The ranking module 235 may compute the expected revenue based on one or more of: a bid price, a budget, and/or targeting criteria associated with an advertisement from the ad request store 230 or associated with a component of one or more advertisements from the ad request store 230. For example, the expected revenue for an advertisement that has a low bid price, a small budget, and a narrow audience is lower than an advertisement with a higher bid price, a larger budget, and a broader audience. Additionally, historical revenue information associated with an advertiser associated with an advertisement may be used to compute expected revenue for the advertisement. For example, the ranking module 235 may account for the amount of revenue previously received by the online system 140 from prior presentation of advertisements associated with an advertiser when determining an expected revenue for an advertisement associated with the advertiser. Additionally, the expected revenue may account for the likelihood of user interaction with an advertisement when determining an expected revenue for the advertisement; for example, the expected revenue for an advertisement accounts for probabilities of a user performing one or more types of interactions with the advertisement.

Additionally, the ranking module 235 determines one or more other factors for an advertisement and determines a score for the advertisement based on the expected revenue for the advertisement and one or more of the factors. For example, the ranking module 235 calculates one or more of: an advertiser experience metric, a quality metric, and a cost to review metric. The advertiser experience metric is based on an estimated time to review an advertisement or a component. In one embodiment, a higher value of the advertiser experience metric corresponds to a shorter turnaround time, which corresponds to a better experience for the advertiser. Information associated with an advertiser, such as volume of advertisements from an advertiser received by or presented by the online system 140 (e.g., a higher value is associated with an advertiser providing 1000 advertisements to the online system 140 than an advertiser providing 10 advertisements to the online system 140) may be used to calculate the advertiser experience metric. Additionally, a partner value may be assigned to an advertiser by the online system 140 reflecting information associated with the advertiser by the online system 140 (e.g., a higher value associated with an advertiser with an advertising contract with the online system 140 than an advertiser without an advertising contract) and used to determine the advertiser experience metric. In one embodiment, the advertiser experience metric also accounts for time-sensitive information in an advertisement that would prioritize an advertisement for publication. For example, the advertiser experience metric may be higher for advertisements describing sponsored stories or flash sales as such advertisements are less likely to be relevant to users after a specified length of time. In another embodiment, the online system 140 may implement one or more rules that prioritize advertisements or components for review after a threshold amount of time has elapsed since the advertisement or component was ranked in the review queue. For example, a score of an advertisement that has been queued for review for at least a threshold amount of time may be increased.

The quality metric indicates the quality of an advertisement. In one embodiment, a higher value corresponds to a higher quality advertisement or to a component of one or more higher-quality advertisements. For an advertisement, the quality metric may be based on user feedback for similar advertisements that have previously been presented. The degree of similarity between previously presented advertisements and an advertisement may affect the quality metric determined for the advertisement based on feedback received for the previously presented advertisements. For example, a number or percentage of components of a previously presented advertisement matching components of an advertisement indicates the degree of similarity between the previously presented advertisement and the advertisement that is used to scale feedback received for the previously presented advertisement when determining the score. In other embodiments, feedback received for a previously presented advertisement accounted for when determining the score for an advertisement if the previously presented advertisement has at least a threshold number or a threshold percentage of components matching components of the advertisement. For a component, the quality metric may be based on user feedback for advertisements including the same or a similar component that have previously been presented. User feedback used to determine a quality score may include both non-explicit feedback (e.g., click-through rate) and explicit feedback (e.g., users directly indicating that they found an advertisement offensive).

In some embodiments, the ranking module 235 associates different weights with feedback from various targeting criteria associated with an advertisement when determining the quality metric. The targeting criteria identify a group of online system users eligible to be presented an advertisement, allowing the ranking module 235 to account for the advertisement's audience. For example, the ranking module 235 assigns a lower weight to advertisements or components of advertisements with broad targeting criteria and a higher weight to advertisements or components of advertisements with narrow targeting criteria in order to expand the advertisement inventory for more narrowly defined audiences. The ranking module 235 may weight the feedback received for an advertisement or for a component of an advertisement when determining the quality metric for the advertisement. Additionally, the ranking module 235 may associate different weights with feedback for advertisements received from different users when determining the quality metric. For example, if the ranking module 235 determines that a user providing feedback is a suspected imposter of another user or is not a member of a demographic group relevant to the advertisement, the ranking module 235 applies a weight to feedback received from the user that lowers the contribution of feedback received from the user to when determining the quality metric.

Additionally, the ranking module 235 determines a cost to review metric based on the resources used by the online system 140 to review an advertisement or a component. For example, the cost to review metric describes the electronic and/or human resources used to review an advertisement or a component. The cost to review metric specifies a monetary value for the amount of electronic or human resources used to evaluate the advertisement for compliance with policies enforced by the online system. In one embodiment, a higher value of the cost to review metric corresponds to a lower amount or monetary amount of resources used for review. As human resources are more expensive than electronic resources and may be necessary to review advertisements or components that are not easily electronically reviewed (e.g., pictures), so in some embodiments the cost to review metric differently weights human resources and electronic resources.

The ranking module 235 combines the expected revenue, the advertiser experience metric, the quality metric, and/or the cost to review metric to generate a score for an advertisement or for a component. In various embodiments, the above described metrics may be used alone or in any suitable combination to determine the score. For example, the ranking module 235 applies one or module to the expected revenue, the advertiser experience metric, the quality metric, and/or the cost to review metric of an advertisement to generate the score for the advertisement. A model applied by the ranking module 235 may associate different weights with different components to generate the score for an advertisement or for a component. Based on scores generated for various advertisements, the ranking module orders advertisements or components in a queue to review for compliance with policies enforced by the online system 140. The advertisements or components are subsequently reviewed for compliance with policies enforced by the online system 140 based on their order in the queue, with advertisements or components having higher orders in the queue being reviewed sooner.

To prevent advertisements from remaining in the queue for review against policies enforced by the online system 140 rather than being presented to the user the ranking module 235 determines a predicted time until advertisements in the queue will be reviewed for compliance with policies enforced by the online system based at least in part on the order of the advertisements in the queue and the resources available for reviewing the advertisements. For example, the ranking module 235 determines a predicted time to review each advertisement (or component) in the queue based on the resources available to the online system 140 to review advertisements or components, components of an advertisement, and an average time taken to review advertisements having at least a threshold number or percentage of characteristics matching components of the advertisement. The predicted time to review an advertisement in the queue may then be determined as a combination of the predicted time to review the advertisement and the predicted times to review advertisements with higher orders in the queue than the advertisement. If the predicted time until an advertisement in the queue will be reviewed for compliance with the policies enforced by the online system 140 exceeds a threshold amount of time, the ranking module 235 includes the advertisement in one or more selection processes for presentation to users before the advertisement is reviewed. The threshold amount of time may vary for advertisements having different characteristics (e.g., advertisements received from different entities, advertisements for different types of products or services, advertisements having different levels of importance).

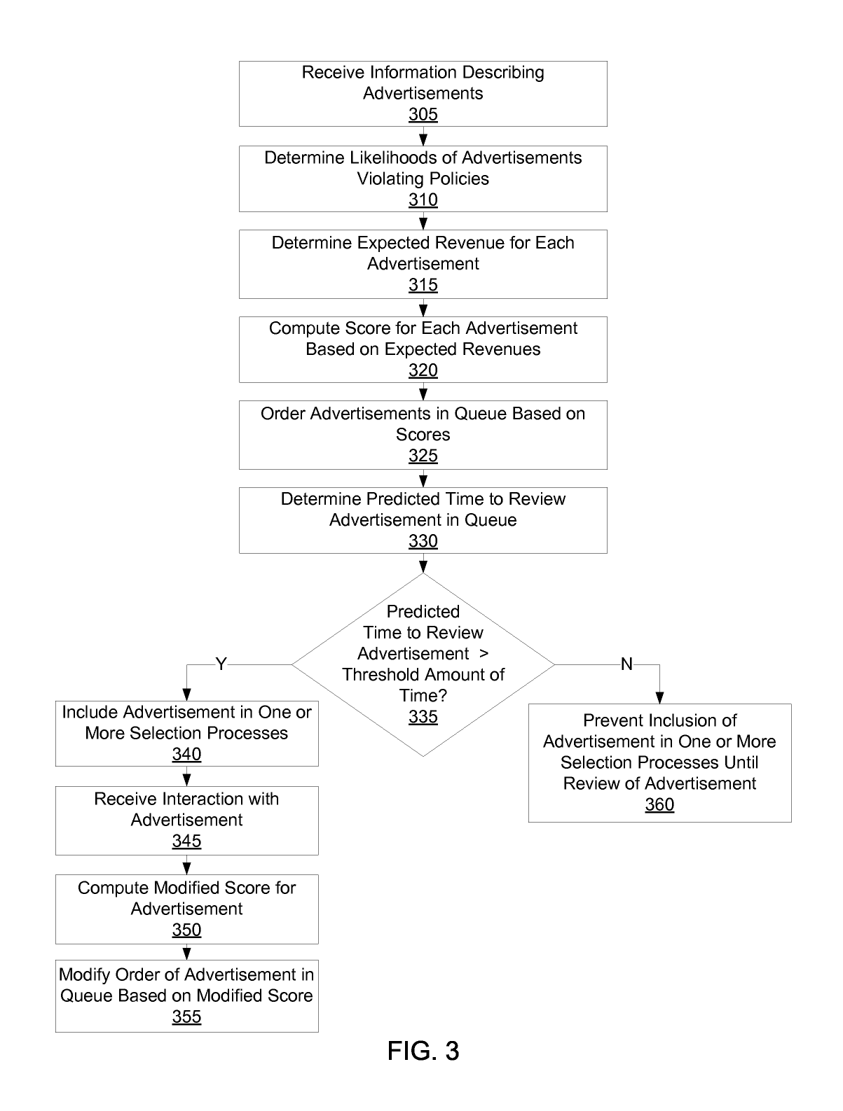

If the online system 140 receives interactions with an advertisement presented without being reviewed for compliance with policies enforced by the online system 140, the ranking module 235 computes a modified score for the advertisement based at least in part on the received interactions with the advertisement. For example, the ranking module 235 computes a modified score for an advertisement presented to a user if the online system 140 receives certain interactions with the advertisement from users presented with the advertisement, such as interactions indicating a lack of interest in (e.g., interactions where the user hides the advertisement or provides a complaint against the advertisement). Hence, the modified score accounts for user interactions with the advertisement after it was presented to users. Based on the modified score, the ranking module 235 modifies the order of advertisements in the queue for review against policies enforced by the online system 140. Hence, the online system 140 may present advertisements to users before reviewing the advertisements for compliance with polices enforced by the online system 140 and subsequently expedite review of the advertisements for compliance with the policies based on received user interactions with the presented advertisements. Ranking of advertisements, or components, based on user interactions with the advertisements or components is further described below in conjunction with FIG. 3.

In some embodiments, the ranking module 235 partitions an advertisement into one or more components. For example, the ranking module 235 partitions an advertisement into one or more of: a title, a body, an image, a landing page, and an account. The title provides a brief description of the advertisement. The body, or text, of an advertisement provides details about a product, service, or other content associated with the advertisement. The image is graphical data displayed by the advertisement. A landing page is a web page, application, web site, or other network destination to which a user is directed when accessing the advertisement. An account identifies an advertiser associated with the advertisement. In other embodiments, advertisements may be partitioned into different and/or additional components.

When evaluating a component of an advertisement for compliance with one or more policies of the online system 140, the ranking module 235 determines whether the ranking module 235 or the ad request store 230 includes data indicating whether a component matching or similar to the component being evaluated satisfies one or more policies of the online system 140. If a match is found, the ranking module retrieves the data associated with the matching or similar component and uses the retrieved data to indicate whether the component being evaluated satisfies one or more policies of the online system 140. If the ranking module 235 determines from information in the ranking module or in the ad request store 230 that a component matching or similar to the component being evaluated is included in a queue for review by the ranking module 235 but has not yet been reviewed for policy compliance, the ranking module 235 may determine a predicted time until the component is to be evaluated for compliance with one or more policies and may present an advertisement including the component to one or more users without review of the component, as further described below in conjunction with FIG. 3. If the ranking module 235 determines that the component being evaluated matches or is similar to a component that has previously been reviewed for policy compliance and that one or more policies have changed since the review, the ranking module 235 determines a score for the component and orders the component in the queue for review against the policies enforced by the online system 140 based on the determined score. Determining similarity between components is further disclosed in U.S. patent application Ser. No. 13/756,357, filed on Jan. 31, 2013, which is hereby incorporated by reference in its entirety.

The web server 240 links the social networking system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the social networking system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

### Advertisement Ranking

FIG. 3 illustrates one embodiment of a method for ranking an advertisement for review. In some embodiments, the method may include different and/or additional steps than those described in conjunction with FIG. 3. Additionally, in some embodiments, the method may perform the steps in different orders than the order described in conjunction with FIG. 3.

The online system 140 receives 305 information describing one or more advertisements from one or more advertisers. For example, the online system 140 receives 305 ad requests from one or more advertisers, with each ad request including an advertisement for presentation to users, a bid amount, targeting criteria, or other suitable information, as described above in conjunction with FIG. 2. The online system 140 determines 310 a likelihood of various advertisements violating one or more policies applied by the online system 140 based on components of the advertisements, prior interactions by users with additional previously presented advertisements having components matching or similar to components of the advertisements, or other suitable information. For example, the online system 140 retrieves stored interactions by users that are associated with identifiers corresponding to various presented advertisements and determines 310 likelihoods of various received advertisements violating one or more policies of the online system 140 based on stored interactions with additional advertisements having at least a threshold similarity to received advertisements. In some embodiments, the online system 140 retrieves information describing certain types of interactions with presented advertisements (e.g., interactions indicating a lack of interest in the advertisement) to determine likelihoods of received advertisements violating one or more policies enforced by the online system 140. Alternatively, the online system 140 retrieves 310 information describing multiple types of interactions with the advertisements.

For each of the received advertisements, the online system 140 determines 315 an expected revenue to the online system 140 that specifies an amount of compensation the online system 140 receives from an advertiser associated with an advertisement for presenting the advertisement. The online system 140 may determine 315 the expected revenue for an advertisement based on one or more of: a bid price of the advertisement, a budget of the advertisement, and targeting criteria associated with the advertisement. Additionally, historical revenue information associated with an advertiser associated with the advertisement may be used to compute expected revenue for the advertisement. The expected revenue determined 315 for the advertisement may account for the likelihood of user interaction with the advertisement based on prior interactions with advertisements having matching or similar characteristics or components to those of the advertisements; for example, the expected revenue determined 315 for an advertisement accounts for probabilities of a user performing one or more types of interactions with the advertisement.

Based at least in part on the expected revenues for various advertisements and likelihoods of various advertisements violating one or more policies applied by the online system 140, the online system 140 computes 320 a score for each of the advertisements. In some embodiments, the scores are also computed 320 based in part on costs to review various advertisements. As described above in conjunction with FIG. 2, the cost to review an advertisement provides a measure of the resources used by the online system 140 to review an advertisement or a component. In various embodiments, the cost to review the advertisement is a monetary value representing a cost to the online system 140 for the human resources and/or the electronic resources expended by the online system 140 to review the advertisement (or the component) for compliance with one or more policies enforced by the online system 140. Additionally, if the advertisement has been presented to one or more users of the online system 140, the score accounts for various interactions with the advertisement by users to whom the advertisement was presented. For example, the online system 140 applies a conversion factor to one or more of the cost to review the advertisement (i.e., the cost to review metric), the expected revenue from presenting the advertisement, and interactions with the advertisement to convert the preceding quantities into a common unit of measurement then combines the quantities to compute 320 the score for the advertisement. In some embodiments, the score for an advertisement represents an expected amount of compensation to the online system 140 from presenting the advertisement. In various embodiments, the online system 140 accounts for an advertiser experience metric associated with an advertisement and/or a quality metric associated with the advertisement, which are described above in conjunction with FIG. 2, when calculating 320 the score for the advertisement. Additionally, the score for the advertisement may be calculated 320 in part on a number of prior reviews of the advertisement against one or more policies enforced by the online system 140. For example, the score for the advertisement is increased if the advertisement has previously been reviewed against one or more policies enforced by the online system 140 less than a threshold number of times. In alternative embodiments, the score for the advertisement is decreased if the advertisement has previously been reviewed against one or more policies enforced by the online system 140 greater than a threshold number of times. In various embodiments, one or more characteristics of the advertisement determine whether the number of times the advertisement has been reviewed against one or more policies enforced by the online system 140 determine whether the online system 140 increases or decreases the score for the advertisement based on the number of times the advertisement has previously been reviewed against the one or more policies enforced by the online system 140.

Based on the scores for various advertisements, the online system 140 orders 325 the advertisements into a queue. In various embodiments, advertisements with larger scores have higher orders in the queue. As described above in conjunction with FIG. 2, the online system 140 uses the ordering of advertisements to determine whether advertisements violate one or more policies enforced by the online system 140. For example, advertisements with higher orders in the queue are reviewed by the online system 140 against policies enforced by the online system 140 sooner than advertisement with lower orders in the queue.

To prevent advertisements from remaining in the queue for review against policies enforced by the online system 140 rather than being presented to the user, the online system 140 determines 330 a predicted time for various advertisements in the queue to be reviewed for compliance with policies enforced by the online system 140 based at least in part on the order of the advertisements in the queue and the resources available to the online system 140 for reviewing the advertisements. For example, the online system 140 determines a predicted time to review each advertisement in the queue based on the resources available to the online system 140 to review advertisements, components of an advertisement, and an average time taken to review advertisements having at least a threshold number or percentage of characteristics or components matching components or characteristics of the advertisement. The online system 140 may then determine 330 a predicted time to review an advertisement in the queue as a combination of the predicted time to review the advertisement and the predicted times to review advertisements with higher orders in the queue than the advertisement. For example, a predicted time to review an advertisement with a 5^{th} position in the queue is a combination of the predicted time to review the advertisement and the predicted times to review the advertisements in the 1^{st} through the 4^{th} positions in the queue.

The online system 140 determines 335 if the predicted time to review an advertisement exceeds a threshold amount of time, and includes 340 the advertisement in one or more selection processes for presentation to users before the advertisement is reviewed in response to determining 335 the predicted time to review the advertisement exceeds the threshold amount of time. In various embodiments, the threshold amount of time varies for advertisements having different characteristics (e.g., advertisements received from different entities, advertisements for different types of products or services, advertisements having different levels of importance). However, if the online system 140 determines 335 the predicted time to review the advertisement is less than the threshold amount of time, the online system 140 does not include the advertisement in one or more selection processes, but instead prevents 360 the advertisement from being evaluated for presentation to users until the online system 140 determines whether the advertisement complies with policies enforced by the online system 140. Hence, rather than have an advertisement remain in the queue for greater than the threshold amount of time, the online system 140 includes advertisements in one or more selection processes to be evaluated for presentation to various users after less than the threshold amount of time.

Additionally, the online system 140 determines an amount of time the advertisement has been included in the queue. If the online system 140 determines the amount of time the advertisement has been included in the queue exceeds a threshold duration, the online system 140 includes 340 the advertisement in one or more selection processes for presentation to users before the advertisement is reviewed. Hence, the online system 140 includes 340 the advertisement in one or more selection processes for presentation to users in response to determining 335 the predicted time to review the advertisement exceeds the threshold amount of time or in response to determining the advertisement has been in the queue for greater than the threshold duration.

When the online system 140 receives 345 one or more interactions with an advertisement presented to users without being reviewed for compliance with policies enforced by the online system 140, the online system 140 computes 350 a modified score for the advertisement based at least in part on the received interactions with the advertisement. For example, the online system 140 computes 350 a modified score for an advertisement presented to a user if the online system 140 receives 345 certain interactions with the advertisement from users presented with the advertisement, such as interactions indicating a lack of interest in the advertisement (e.g., interactions where the user hides the advertisement or provides a complaint against the advertisement). As another example, the online system 140 computes 350 the modified score for the advertisement if the online system 140 receives 345 at least a threshold number of interactions with the advertisement by users presented with the advertisement. Hence, the modified score accounts for user interactions with the advertisement when it was presented to users. Based on the modified score, the online system 140 modifies 355 the order of advertisements in the queue to review for compliance with policies enforced by the online system 140 and determines when to review advertisements for compliance with policies enforced by the online system based on the modified order. Hence, the online system 140 may present advertisements to users before reviewing the advertisements for compliance with polices enforced by the online system 140 and subsequently expedite or delay review of the advertisements for compliance with the policies based on received user interactions with the presented advertisements.

Additionally, the online system 140 may compute 350 modified scores for advertisements and modify 355 the order of advertisements in the queue based on the modified scores when other conditions are satisfied. For example, the online system 140 computes 350 modified scores for the advertisements if at least a threshold time interval has lapsed between a current time and a time when the one or more advertisements were ordered 325 in the queue and modifies 355 the order of the advertisements in the queue based on the modified scores. When computing 350 the modified scores, the online system 140 may account for interactions by users with the advertisements between the current time when the advertisements were ordered 325 in the queue as well as changes in the resources available to the online system 140 for reviewing advertisements for compliance with policies enforced by the online system 140, which may increase or decrease the cost to review metric for various advertisements. In some embodiments, the online system 140 computes 350 modified scores for advertisements at periodic times after advertisements are ordered 325 in the queue and modifies 355 the order of advertisements in the queue based on the modified scores, allowing the order of advertisements in the queue to more accurately account for changes in resources available to the online system 140 for reviewing advertisements and interactions with presented advertisements over time. As another example, the online system 140 computes 350 modified scores for advertisements if a model used to compute 320 the scores is modified between a time when the scores were computed 320 and a current time. Based on the modified scores, the online system 140 modifies 355 the order of advertisements in the queue, allowing evaluation of advertisements against policies enforced by the online system 140 to account for changes in calculation of scores for advertisements over time.

While FIG. 3 describes ordering and modifying an order of advertisements based on scores computed 320 for the advertisements, in other embodiments, the online system computes 320 scores for components of advertisements and orders 325 the components in a queue for review against policies enforced by the online system based on the order of the components in the queue. The online system may determine 330 a predicted time until a component of an advertisement will be evaluated for compliance with the one or more policies and include 340 the advertisement in one or more selection processes for presentation to users if the predicted time equals or exceeds a threshold amount of time, as described above in conjunction with FIG. 3. Additionally, the online system 140 may determine an amount of time the component has been in the queue and include 340 the advertisement including the component in one or more selection processes for presentation if the component has been in the queue for greater than a threshold duration. Also as described above, as the online system 140 receives interactions with presented advertisements including the component, the online system 140 computes 350 modified scores for the component and modifies 355 the order of the component in the queue for evaluation against policies enforced by the online system 140 based on the modified score. Modified scores of components may be computed 350 and the order of components in the queue modified 355 based on satisfaction of other conditions, as described above in conjunction with FIG. 3.

While FIG. 3 describes an embodiment that ranks an advertisement for review, the method described in conjunction with FIG. 3 may be used to rank various types of content items for review. In various embodiments, any content item provided to an online system 140 for presentation to be presented to users of the online system 140 may be ranked as described above in conjunction with FIG. 3 for review against policies enforced by the online system. For example, the online system 140 determines 310 a likelihood of various content items violating one or more policies applied by the online system 140 based on components of the content items, prior interactions by users with additional previously presented content items having components matching or similar to components of the content items, or other suitable information. For example, the online system 140 retrieves stored interactions by users that are associated with identifiers corresponding to various presented content items and determines 310 likelihoods of various received content items violating one or more policies of the online system 140 based on stored interactions with additional content items having at least a threshold similarity to received content items. In some embodiments, the online system 140 retrieves information describing certain types of interactions with presented content items (e.g., interactions indicating a lack of interest in the content items) to determine likelihoods of received content items violating one or more policies enforced by the online system 140. Alternatively, the online system 140 retrieves 310 information describing multiple types of interactions with the content items. For each of the received content items, the online system 140 determines 315 an expected amount of interaction with the received content items based on historical interactions by users with other content items (e.g., prior interactions with content items having matching or similar characteristics or components to those of the received content items) or any other suitable information. Based on the expected amount of interaction with a content item and a likelihood of the content item violating one or more policies enforced by the online system 140, the online system 140 determines 320 a score for the content item. Additional factors, such as those described above in conjunction with FIG. 3 may also be used by the online system 140 to determine 320 the score for the content item. Based on the score for the content item, the online system 140 orders 325 the content item in a queue and performs the subsequent steps described above in conjunction with FIG. 3 to order the content item for review against policies enforced by the online system 140.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, at an online system, information describing one or more advertisements from one or more advertisers;
determining a likelihood of each of the one or more advertisement violating one or more policies of the online system;
for each of the one or more advertisements, determining an expected revenue for presenting the advertisement based on one or more of a group consisting of:
an amount charged to an advertiser for presenting the advertisement, a budget for presenting the advertisement, targeting criteria defining a target group of users of the online system for receiving the advertisement, historical revenue information associated with the advertiser, and any combination thereof;
computing a score for each of the one or more advertisements, the score for the advertisement based at least in part on the likelihood of the advertisement violating one or more policies of the online system and the expected revenue for presenting the advertisement;
ordering the one or more advertisements to be reviewed into a queue based at least in part on the computed scores;
determining a predicted time until the advertisement is to be reviewed to determine whether the advertisement violates one or more policies of the online system based at least in part on an order of the advertisement in the queue; and
responsive to determining the predicted time exceeds a threshold amount of time, including the advertisement in a selection process for presenting content for presentation to a user.

2. The method of claim 1, further comprising:
responsive to determining the predicted time does not exceed the threshold amount of time, reviewing the advertisement based on the order of the advertisement in the queue to determine whether the advertisement violates one or more policies of the online system; and
responsive to determining the advertisement does not violate one or more policies of the online system, including the advertisement in the selection process presenting content for presentation to the user.

3. The method of claim 1, further comprising:
determining an amount of time the advertisement has been in the queue; and
responsive to determining the amount of time exceeds a threshold duration, including the advertisement in a selection process for presenting content for presentation to a user.

4. The method of claim 1, further comprising:
receiving an interaction with the advertisement from a user to whom the advertisement that indicates a lack of interest in the advertisement;
modifying the score for the advertisement based at least in part on the received interaction based at least in part on information describing interactions with the advertisement, the received interaction, the likelihood of the advertisement violating one or more policies of the online system, and the expected revenue for presenting the advertisement; and
modifying the order of the advertisements in the queue based at least in part on the modified score for the advertisement.

5. The method of claim 1, further comprising:
determining at least a threshold time interval has lapsed between a time when a current time and a time when the one or more advertisements were ordered into the queue;
in response to the determining, calculating a modified score for one or more of the advertisements at the current time based at least in part on information describing likelihoods of the advertisements violating one or more policies of the online system at the current time and the expected revenue for presenting the advertisements at the current time; and
modifying the order of the advertisements in the queue based at least in part on the calculated modified scores.

6. The method of claim 5, wherein calculating the modified score for one or more of the advertisements at the current time comprises:
calculating the modified score for the advertisement in response to the advertisement having one or more specified characteristics.

7. The method of claim 6, wherein a specified characteristic comprises an indication the advertisement has a specific level of importance.

8. The method of claim 1, wherein computing the score for each of the one or more advertisements comprises:
applying a model to the information describing interactions with the advertisement, the expected revenue for presenting the advertisement, and the cost to review metric for the advertisement to generate the score for the advertisement.

9. The method of claim 8, further comprising:
determining the model has been modified; and
responsive to the determining, computing a modified score for each of the one or more advertisements, the modified score for the advertisement computed by applying the modified model to the likelihood of the advertisement violating one or more policies of the online system and the expected revenue for presenting the advertisement.

10. The method of claim 1, wherein the score for the advertisement is further based at least in part on a cost to review metric for the advertisement.

11. The method of claim 10, wherein the cost to review metric for the advertisement indicates an estimated amount of resources needed to determine whether the advertisement violates the one or more policies of the online system.

12. A computer program product comprising a non-transitory computer readable storage medium having instructions encoded thereon that, when executed by a processor, cause the processor to:
receive, at an online system, information describing one or more advertisements from one or more advertisers;
determine a likelihood of each of the one or more advertisement violating one or more policies of the online system;
for each of the one or more advertisements, determine an expected revenue for presenting the advertisement based on one or more of a group consisting of:
an amount charged to an advertiser for presenting the advertisement, a budget for presenting the advertisement, targeting criteria defining a target group of users of the online system for receiving the advertisement, historical revenue information associated with the advertiser, and any combination thereof;
compute a score for each of the one or more advertisements, the score for the advertisement based at least in part on the likelihood of the advertisement violating one or more policies of the online system and the expected revenue for presenting the advertisement;
order the one or more advertisements to be reviewed into a queue based at least in part on the computed scores;
determine a predicted time until the advertisement is to be reviewed to determine whether the advertisement violates one or more policies of the online system based at least in part on an order of the advertisement in the queue; and
responsive to determining the predicted time exceeds a threshold amount of time, include the advertisement in a selection process for presenting content for presentation to a user.

13. The computer program product of claim 12, wherein the computer readable storage medium further has instructions encoded thereon that, when executed by the processor, cause the processor to:
responsive to determining the predicted time does not exceed the threshold amount of time, review the advertisement based on the order of the advertisement in the queue to determine whether the advertisement violates one or more policies of the online system; and
responsive to determining the advertisement does not violate one or more policies of the online system, include the advertisement in the selection process presenting content for presentation to the user.

14. The computer program product of claim 12, wherein the computer readable storage medium further has instructions encoded thereon that, when executed by the processor, cause the processor to:
determine an amount of time the advertisement has been in the queue; and
responsive to determining the amount of time exceeds a threshold duration, include the advertisement in a selection process for presenting content for presentation to a user.

15. The computer program product of claim 12, wherein the computer readable storage medium further has instructions encoded thereon that, when executed by the processor, cause the processor to:
receive an interaction with the advertisement from a user to whom the advertisement that indicates a lack of interest in the advertisement;
modify the score for the advertisement based at least in part on the received interaction based at least in part on information describing interactions with the advertisement, the received interaction, the likelihood of the advertisement violating one or more policies of the online system, and the expected revenue for presenting the advertisement; and
modify the order of the advertisements in the queue based at least in part on the modified score for the advertisement.

16. The computer program product of claim 12, wherein the computer readable storage medium further has instructions encoded thereon that, when executed by the processor, cause the processor to:
determine at least a threshold time interval has lapsed between a time when a current time and a time when the one or more advertisements were ordered into the queue;
in response to the determining, calculate a modified score for one or more of the advertisements at the current time based at least in part on information describing likelihoods of the advertisements violating one or more policies of the online system at the current time and the expected revenue for presenting the advertisements at the current time; and
modifying the order of the advertisements in the queue based at least in part on the calculated modified scores.

17. The computer program product of claim 16, wherein calculate the modified score for one or more of the advertisements at the current time comprises:
calculate the modified score for the advertisement in response to the advertisement having one or more specified characteristics.

18. The computer program product of claim 17, wherein a specified characteristic comprises an indication the advertisement has a specific level of importance.

19. The computer program product of claim 12, wherein compute the score for each of the one or more advertisements comprises:
apply a model to the information describing interactions with the advertisement, the expected revenue for presenting the advertisement, and the cost to review metric for the advertisement to generate the score for the advertisement.

20. The computer program product of claim 19, wherein the computer readable storage medium further has instructions encoded thereon that, when executed by the processor, cause the processor to:
determine the model has been modified; and
responsive to the determining, compute a modified score for each of the one or more advertisements, the modified score for the advertisement computed by applying the modified model to the likelihood of the advertisement violating one or more policies of the online system and the expected revenue for presenting the advertisement.
